(19) United States
(12) Patent Application Publication
(10) Pub. No.: US 2024/0131941 A1
(43) Pub. Date: Apr. 25, 2024

(54) POLE ASSEMBLY FOR ON-ROUTE VEHICLE CHARGING

(71) Applicant: Valmont Industries, Inc., Omaha, NE (US)

(72) Inventor: Mark Perina, Omaha, NE (US)

(73) Assignee: Valmont Industries, Inc., Omaha, NE (US)

(21) Appl. No.: 18/484,630

(22) Filed: Oct. 10, 2023

Related U.S. Application Data
(60) Provisional application No. 63/380,097, filed on Oct. 19, 2022.

(51) Int. Cl. B60L 53/31; B60L 53/16; B60L 53/30

(52) U.S. Cl. CPC B60L 53/31; B60L 53/16; B60L 53/32

(57) ABSTRACT

A new pole design for on-route vehicle charging systems. According to preferred embodiments, the improved pole design of the present invention includes a removable hinge to allow the structure to be shipped on standard height flatbed trailers, fully wired, from the manufacturing facility.

### RELATED APPLICATIONS

The present application claims priority to U.S. Provisional Application No. 63/380,097 filed Oct. 19, 2022.

### BACKGROUND AND FIELD OF THE PRESENT INVENTION

### Field of the Present Invention

The present invention teaches a new pole design for on-route vehicle charging. According to preferred embodiments, the present invention teaches an improved pole assembly for charging of electric vehicles.

### Background of the Invention

Electric service poles, including those used for over-head vehicle charging and the like, are typically structures which require several different parts to be assembled on-site after transportation. Typically, these include a vertical pole section for securing a pavement surface and an arm for extending over a roadway. Because of the forces and distances involved, both the vertical pole section and the horizontally extending arm are generally heavy, ruggedized components. Additionally, wiring of the assembled poll is required to be on-site.

Typically, this assembly process requires large machinery and several man hours. Further, the electrical components and wiring are only installed once the structure is erected at the location. This wiring process is very laborious and requires multiple machines and electricians to properly coordinate. Even with extensive time invested in the process, many errors can occur during assembly, wiring and installation. This process is even more complicate for charging stations for buses and the like which include significantly heavier and more complex wiring.

What is needed is an improved design which is able to be transported, assembled, wired and emplaced with minimal man hours and reduced complexity.

### SUMMARY OF THE DISCLOSURE

To minimize the limitations found in the prior art, and to minimize other limitations that will be apparent upon the reading of the specifications, the present invention teaches a new pole design for on-route vehicle charging systems.

According to preferred embodiments, the improved pole design of the present invention includes a removable hinge to allow the structure to be shipped on standard height flatbed trailers, fully wired, from the manufacturing facility.

According to a further aspect, the improved pole assembly of the present invention includes a central hinge between the vertical pole and a horizontally extended arm. During transport, the improved pole assembly preferably may be collapsed along the central hinge to reduce in size.

According to further aspects, the improved pole assembly of the present invention may be off-loaded from a given transport with a small crane and placed on anchor bolts in a folded position. According to a further aspect, the small crane may then pivot the collapsed arm of the improved pole assembly into a final position. Once in the horizontal position, the extended arm may preferably be locked into place. The central hinge may then be removed or may be bolted and locked into place to support the extended arm.

### BRIEF DESCRIPTION OF THE DRAWINGS

FIG. 1 is an illustration of an exemplary pole assembly in accordance with a first preferred embodiment of the present invention.

FIG. 2 shows a head-on view of the exemplary pole assembly shown in FIG. 1.

FIG. 3 is an enlarged side-view of an exemplary bus charger for use in accordance with a preferred embodiment of the present invention.

FIG. 4 is a perspective view of an exemplary central hinge for use with aspects of the present invention.

FIG. 5 is a side view of the exemplary central hinge shown in FIG. 4.

FIG. 6 is a side, perspective view illustrating an alternative embodiment of a pole assembly of the present invention illustrating a charger in an extended position for charging.

FIG. 7 is an illustration of multiple collapsed pole assemblies arranged for transport.

FIG. 8 is an illustration of a pair of installed pole assemblies arranged for charging an exemplary vehicle.

FIG. 9 is an illustration of a first exemplary pole which is extended for installation and use.

FIG. 10 is an illustration of the same first exemplary pole which is collapsed for transport.

FIG. 11 is an enlarged view of an exemplary internal yoke system of the present invention as indicated in FIG. 10.

FIG. 12 is a further enlarged view of the exemplary internal yoke structure of the present invention attached between two pole sections.

FIG. 13 is a view of an exemplary internal yoke structure of the present invention independent of the attached pole sections.

FIG. 14 is a partially exploded view of a section of the exemplary internal yoke structure of the present invention shown in FIG. 13.

### DESCRIPTION OF THE PREFERRED EMBODIMENTS

Aspects of the present invention will be explained with reference to exemplary embodiments and examples which are illustrated in the accompanying drawings. These descriptions, embodiments and figures are not to be taken as limiting the scope of the claims. Further, the word “exemplary” is used herein to mean “serving as an example, instance, or illustration.” Accordingly, any embodiment described herein as “exemplary” is not to be construed as preferred over other embodiments. Additionally, well-known elements of the embodiments will not be described in detail or will be omitted so as not to obscure relevant details.

Where the specification describes advantages of an embodiment or limitations of other prior art, the applicant does not intend to disclaim or disavow any potential embodiments covered by the appended claims unless the applicant specifically states that it is “hereby disclaiming or disavowing” potential claim scope. Likewise, the term “embodiments” does not require that all embodiments of the invention include any discussed feature or advantage, nor that it does not incorporate aspects of the prior art which are sub-optimal or disadvantageous.

As used herein, the singular forms “a”, “an” and “the” are intended to include the plural forms as well, unless the context clearly indicates otherwise. Additionally, the word “may” is used in a permissive sense (i.e., meaning “having the potential to”), rather than the mandatory sense (i.e., meaning “must”). Further, it should also be understood that throughout this disclosure, unless logically required to be otherwise, where a process or method is shown or described, the steps of the method may be performed in any order (i.e., repetitively, iteratively or simultaneously) and selected steps may be omitted. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

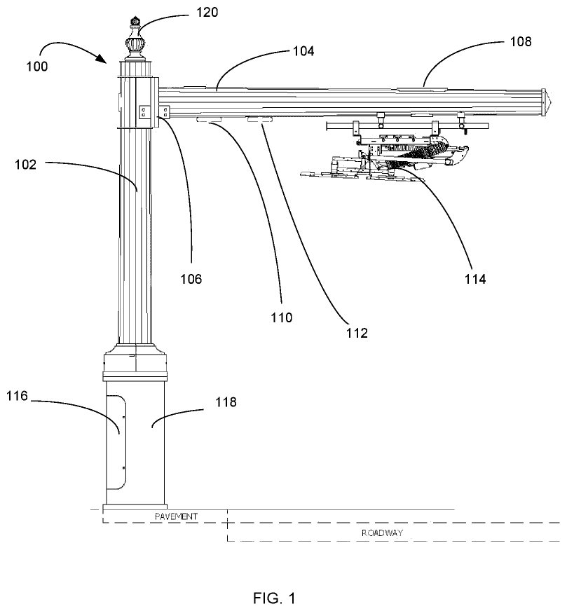

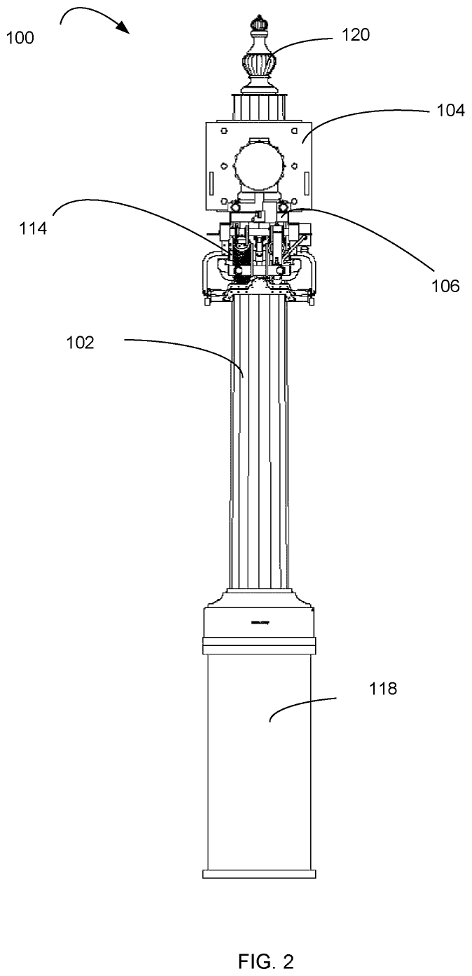

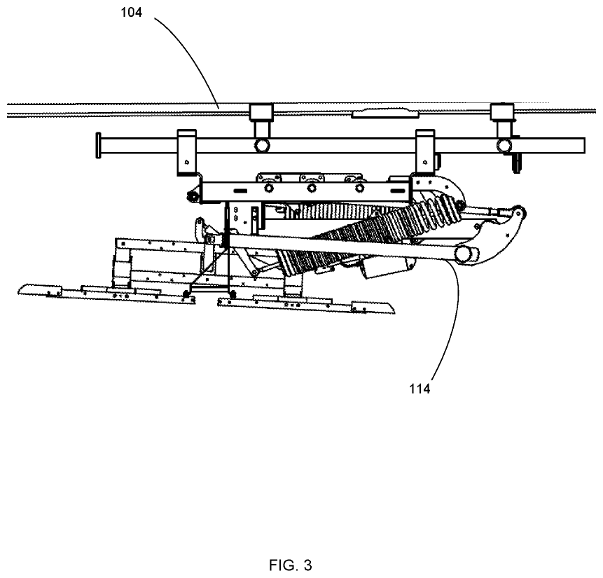

With reference now to FIGS. 1-5, a first exemplary pole assembly 100 in accordance with a preferred embodiment of the present invention shall now be discussed. As shown in FIGS. 1-2, a first exemplary pole assembly 100 of the present invention preferably includes a first vertical pole 102 which includes a base 118. The base 118 may be detachable or may be integral with the main vertical pole 102. The vertical pole 102 may also include a cap 120 or top section which may also be detachable or may be integral with the main vertical pole 102. As shown, the base 118 may also include an access panel 116 or the like for connecting and adjusting internal wiring as discussed further below.

As further shown in FIGS. 1-3, the pole assembly 100 preferably further includes a horizontal arm 104. According to preferred embodiments, the horizontal arm 104 may preferably be attached to the vertical pole 102 and held in place via a hinge mechanism 106. Preferably, the hinge mechanism 106 may be connected to and/or built into the pole assembly 102 at a connection point between the vertical section 102 and the horizontal arm 104. The central hinge assembly 106 preferably facilitates collapsing the horizontal arm 104 as discussed further below.

As shown, the horizontal arm 104 may preferably include one or more access panels 108 or handholes to provide access to internal wiring and bolts. According to a preferred embodiment, the horizontal arm 104 may preferably include bolt holes and other access points to allow for suspending various devices over a given roadway. As shown, these devices may include devices such as: a Wi-Fi antenna 110, an RFID antenna 112, and a charging device 114.

The charging device 114 of the present invention may preferably be a charging device capable of extending down and being positioned over a given vehicle in order to charge or power a vehicle battery or the like. According to a first preferred embodiment, the charging device 114 may be an inverted pantograph or the like that can recharge different vehicles at a given depot or charging station. Such charging may include pulse charging (i.e., 1 MW for 30 s) or longer duration charging using continuous current. Other types of charging type devices may be used with the present invention without limitation.

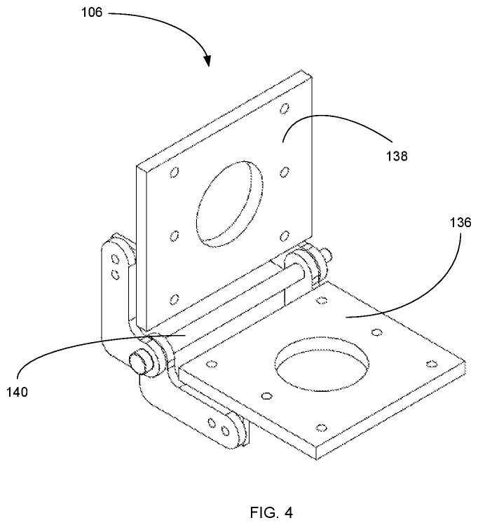

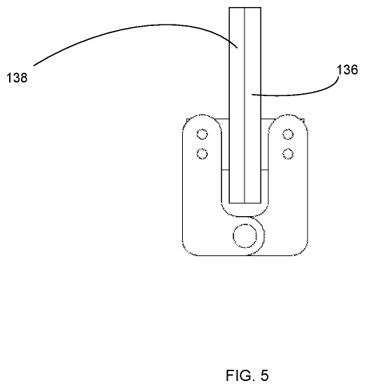

With reference now to FIGS. 4-5, the central hinge assembly 106 of the present invention may preferably include a lower hinge surface 136, an upper hinge surface 138, and a central hinge 140. According to a preferred embodiment, the upper hinge surface 138 may preferably be secured to a vertical pole 102. Likewise, the lower hinge surface 136 may preferably be attached to a surface of the horizontal arm 104. As discussed above, the central hinge assembly 106 is preferably movable between an open position and a closed position to allow the horizontal arm 104 to be lowered and raised with respect to the orientation of the vertical pole 102. In this way, the pole assembly may be collapsed and/or extended for use.

According to a first preferred embodiment, in a first open position (as shown in FIG. 4) the upper hinged surface 138 and the lower hinged surface 136 are preferably arranged to form an angle which may be in the range of 50° to 90°. In this way, the horizontal arm 104 of a given pole assembly 100 of the present invention may be collapsed. Conversely, the upper hinged surface 138 and the lower hinged surface 136 may preferably be arranged to form an angle in the range of 0° to 25° (as shown in FIG. 5). In this position, the horizontal arm 104 of the example pole assembly 100 may be extended for use.

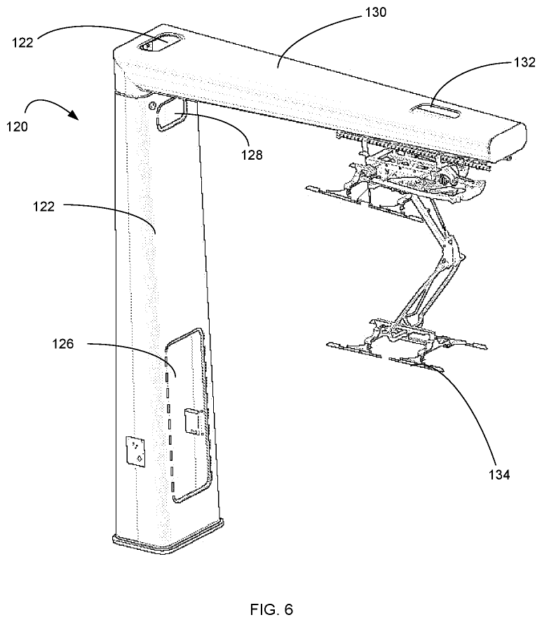

With reference now to FIGS. 6-14, further alternative preferred embodiments of the present invention shall now be discussed. Referring first to FIG. 6, an exemplary pole assembly 120 may include a first vertical pole 122 and a horizontal arm 130. As shown, the main vertical pole 122 and horizontal arm 130 may include one or more access panels 126 and access/handholes 128, 132 as discussed above. Further, the horizontal arm 130 may preferably attach to and support a charger 134 as discussed above. According to preferred embodiments, the horizontal arm 130 may preferably be attached to the vertical pole 122 and held in place via a hinge mechanism (not shown) connected to and/or built into the pole assembly 122. As shown, the exemplary charger 134 may be extended downward to accommodate charging as discussed further below.

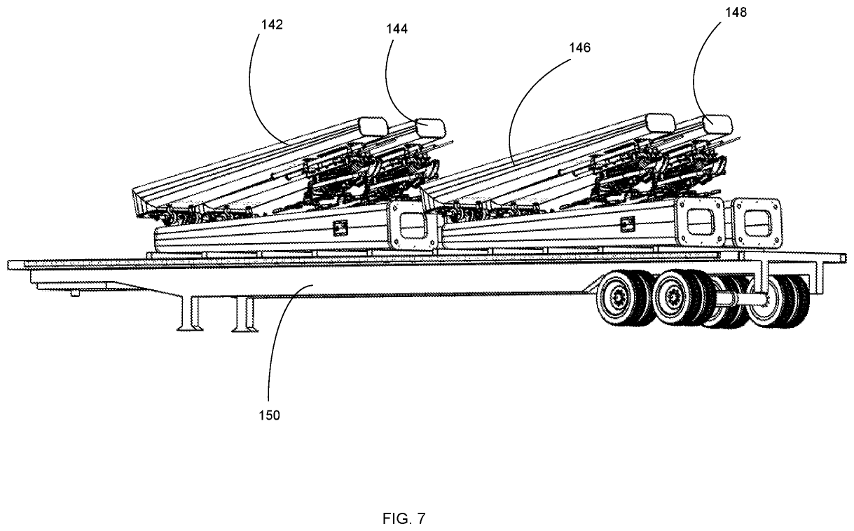

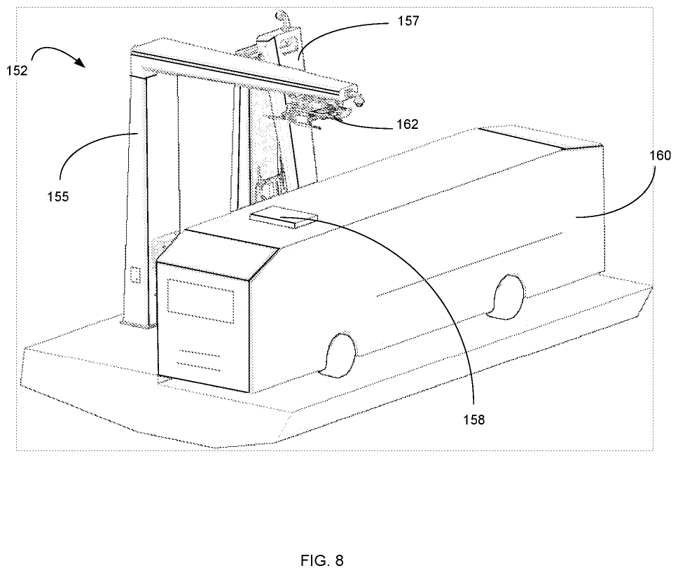

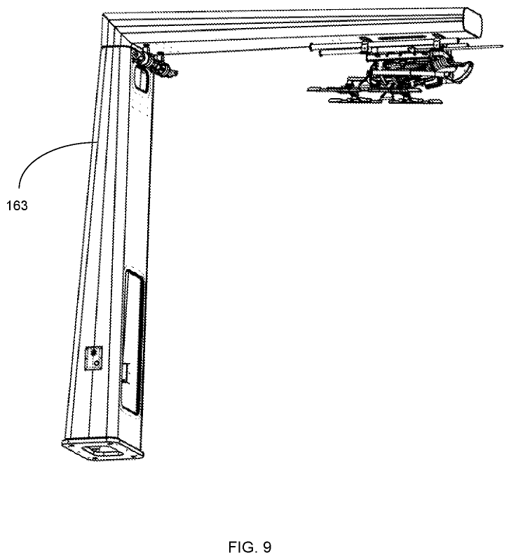

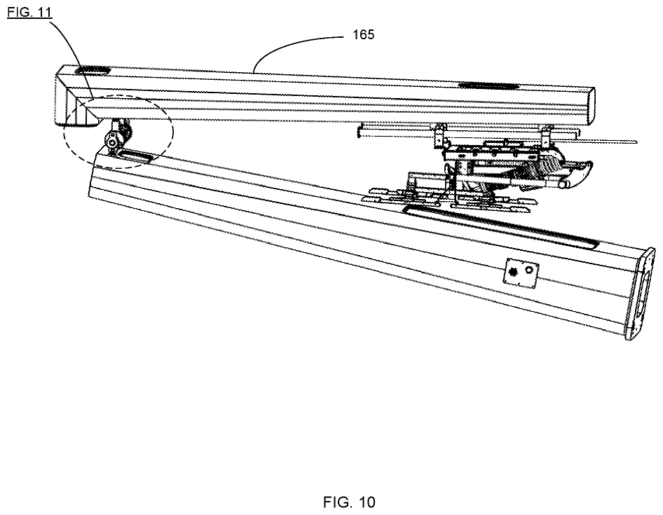

FIG. 9 provides a further illustration of a first pole assembly 163 in a first extended position for installation and use. FIG. 10 provides an illustration of the same first pole assembly in a second collapsed position 165 for storage and/or transport. In FIG. 7, multiple collapsed pole assemblies 142, 144, 146, 148 are shown arranged for transport on an exemplary trailer 150. FIG. 8 provides an illustration of an example charging station 152 including multiple pole assemblies 155, 157. According to preferred embodiments, each pole assembly 155, 157 may be raised and moved into an extended charging position. Alternatively, each pole assembly 155, 157 may be collapsed for servicing or the like. In FIG. 8, the first pole assembly 155 is in a first extended position, and the second pole assembly 157 is in a collapsed position. As discussed above, when in an extended position (i.e., pole assembly 155), the charger 162 may be lowered to provide a charge to a charging device/panel 158 of a given vehicle/bus 160.

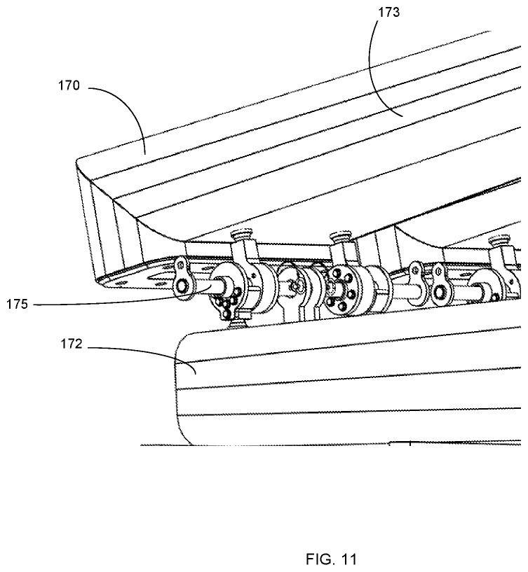

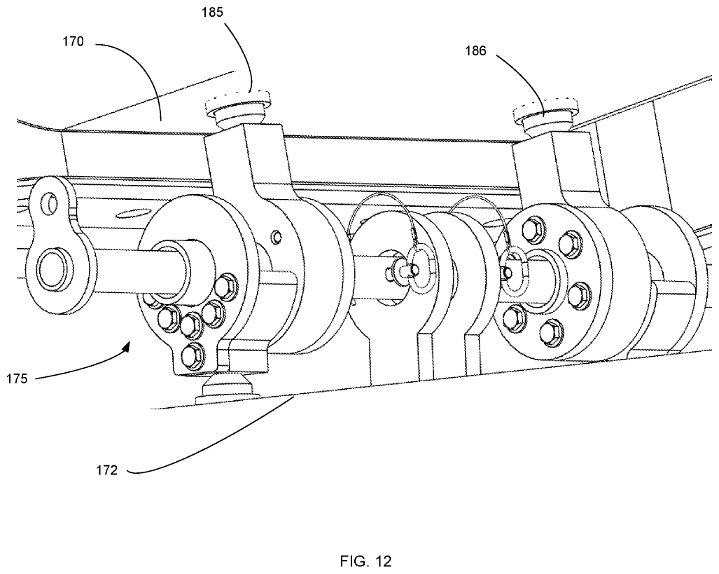

With reference now to FIGS. 11-14, an alternative exemplary hinge/yoke mechanism 175 for facilitating the collapsing and extension of pole sections shall now be discussed. As shown in FIG. 11, according to a preferred embodiment, an upper pole section 170 and a lower pole section 172 of a given pole assembly 173 are preferably movably connected to each other via an attached internal yoke 175. FIG. 12 provides a further enlarged view of the exemplary internal yoke 175 indicated in FIG. 11 attached between the upper pole section 170 and the lower pole section 172.

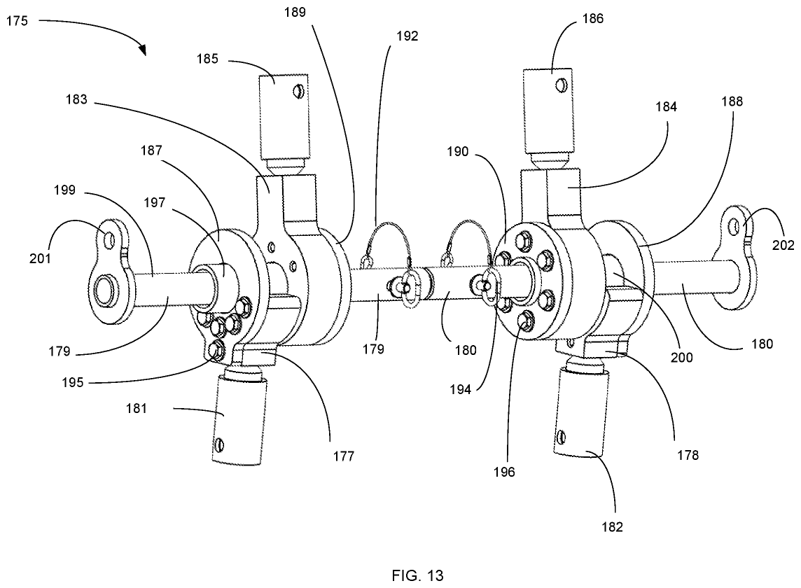

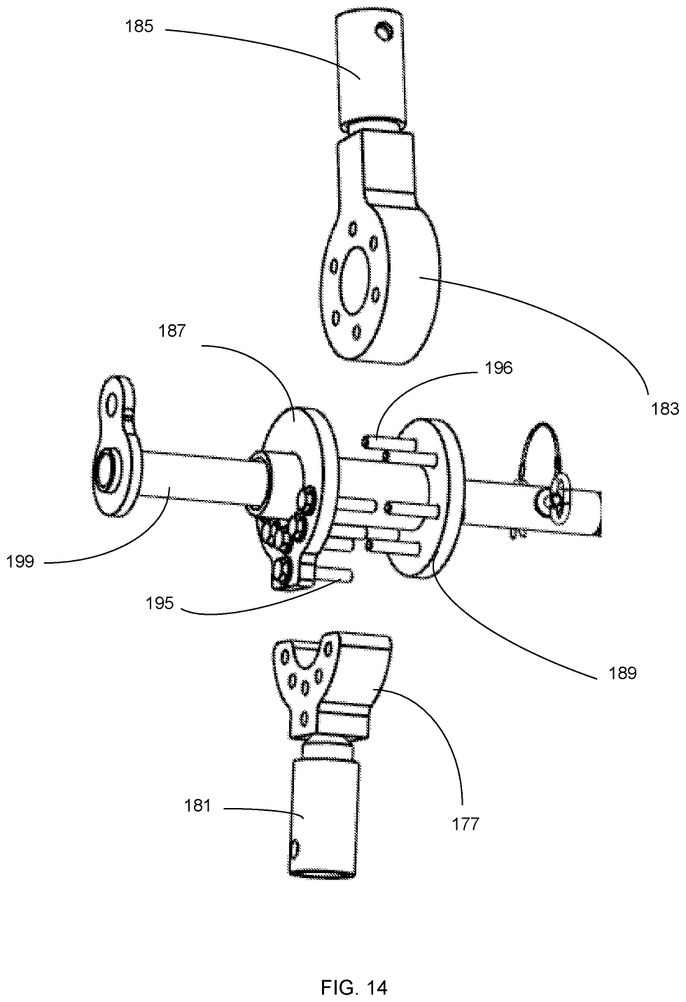

With reference now to FIG. 13, a view of an exemplary internal yoke structure 175 of the present invention (independent of the attached pole sections 170, 172) is provided. Additionally, FIG. 14 provides a further partially exploded view of a section of the exemplary internal yoke structure 175. As shown in FIGS. 13-14, the exemplary yoke structure 175 may preferably include a pair of yoke arms 177, 178 which may be secured to a lower pole section 172 (shown in FIG. 12) using yoke arm anchor mounts 181, 182 embedded within/attached to the lower pole section 172. As shown, the yoke arms 177, 178 may preferably include a circular or semi-circular cradle mount which preferably may support and secure one or more sections 179, 180 of a central shaft 199. As shown, the central shaft 199 may be inserted through and secured within the yoke arms 177, 178 via respective yoke arm securing plates 187, 188 or the like. As shown, each yoke arm securing plate 187, 188 may extend around respective central shaft sections 179, 180 and may be bolted to respective yoke arms 177, 178.

As further shown in FIGS. 13-14, the exemplary yoke structure 175 may preferably also include a pair of pivot arms 183, 184 which may preferably be secured to an upper pole section 170 (shown in FIG. 12) using pivot arm anchor mounts 185, 186 or the like. As shown in FIG. 12, the pivot arm anchor mounts 185, 186 may be attached to or otherwise embedded within the upper pole section 170. As shown in FIGS. 12-14, the pivot arms 183, 184 may be formed as circular housings extending around respective sections of the central shaft 179, 180. Alternatively, the pivot arms 183, 184 may be formed as semi-circular, cradle shapes similar to the yoke arms 177, 178. As further shown, the pivot arms 183, 184 may preferably be further secured via respective pivot arm securing plates 189, 190.

Accordingly, the yoke arms 177, 178 and the pivot arms 183, 184 are preferably secured between respective yoke arm securing plates 187, 188 and respective pivot arm securing plates 189, 190 via groups of bolts 195, 196 which extend through each securing plate 187, 188, 189, 190 and into the respective adjacent yoke arms 177, 178 and/or pivot arms 183, 184. As shown, central tubes 197, 200 may be welded to the pivot arm securing plates 189, 190. Thus, the respective pivot arms 183, 184 may be allowed to pivot relative to the yoke arms 177, 178 (and yoke arm securing plates 187, 188) forming a main pivot axis.

According to a preferred embodiment, the central shaft 199 may be formed of one or more different sections 179, 180 which may be integrated together using a variety of different securing mechanisms. For example, the central shaft sections 179, 180 may be connected using a solid, central tube/round (not shown) inserted within the hollow central shaft sections 179, 180 and secured by securing hitch pins 192, 194 or the like.

The lifting ears 201, 202 may preferably be sized/fitted to accept inserted shackles (not shown) or the like. The lifting ears 201, 202 preferably may thus serve as rigging points for the assembly 163 during loading and installation. In operation, when lifted, the hinge/yoke mechanism 175 may preferably allow the pole assembly 163 to hang plumb when suspended by a crane to allow for installation onto anchor bolts or the like. During this process, the yoke arm securing plates 187, 188 preferably prevent the central tubes 197, 200 from lifting from the yoke arms 177, 178.

The scope of the present invention should be determined not by the embodiments illustrated, but by the appended claims and their legal equivalents.

What is claimed is:

1. A pole assembly for supporting on-route vehicle charging systems, wherein the pole assembly comprises:
a first vertical section;
a horizontally extending arm;
a central hinge assembly; wherein the central hinge assembly comprises: an upper hinge surface, a central hinge, and a lower hinge surface; wherein the lower hinge surface is secured to a first near surface of the horizontally extending arm; wherein the upper hinge surface is secured to a first upper surface of the first vertical section;
wherein the central hinge assembly is movable between a first open position and a second closed position; wherein in the first open position the upper hinged surface and the lower hinged surface are arranged to form an angle selected from the group of angles comprising angles between 50° and 90°;
wherein in the second closed position the upper hinged surface and the lower hinged surface are arranged to form an angle selected from the group of angles comprising angles between 0° and 25°; and
a vehicle charging element; wherein the vehicle charging element is secured to the horizontally extending arm; wherein the vehicle charging element is movable between an extended charging position and a retracted position.

2. A pole assembly for supporting on-route vehicle charging systems, wherein the pole assembly comprises:
a first upper pole section;
a second lower pole section;
a vehicle charging element; wherein the vehicle charging element is secured to the first upper pole section; wherein the vehicle charging element is movable between an extended charging position and a retracted position; and
a central hinge assembly; wherein the central hinge assembly is configured to move between a first open position and a second closed position.

3. The pole assembly of claim 2, wherein the central hinge element comprises:
a central shaft;
a first outside securing plate;
a first lower anchor mount;
a first yoke arm;
a first pivot arm;
a first upper anchor mount; and
first inside securing plate;
wherein the first yoke arm extends partially around the central shaft; wherein the first yoke arm is attached to the first lower anchor mount; wherein the first lower anchor mount is attached to the second lower pole section.

4. The pole assembly of claim 3, wherein the first outside securing plate comprises a first central opening; wherein the central shaft extends through the first central opening.

5. The pole assembly of claim 4, wherein the first outside securing plate is fixedly attached to the first yoke arm; wherein the first outside securing plate is rotatably attached to the central shaft.

6. The pole assembly of claim 5, wherein the first pivot arm comprises a second central opening; wherein central shaft extends through the second central opening.

7. The pole assembly of claim 6, wherein the first inside securing plate comprises a third central opening; wherein the central shaft extends through the third central opening; wherein the first inside securing plate is fixedly attached to the first pivot arm.

8. The pole assembly of claim 7, wherein the first pivot arm is fixedly attached to the first upper anchor mount; wherein the first upper anchor mount is attached to the first upper pole section.

9. The pole assembly of claim 8, wherein the first inside securing plate and the first pivot arm are rotatably attached to the central shaft.

10. The pole assembly of claim 9, wherein the central hinge element comprises:
a second outside securing plate;
a second lower anchor mount;
a second yoke arm;
a second pivot arm;
a second upper anchor mount; and
a second inside securing plate;
wherein the second yoke arm extends partially around the central shaft; wherein the second yoke arm is attached to the second lower anchor mount; wherein the second lower anchor mount is attached to the second lower pole section.

11. The pole assembly of claim 10, wherein the second outside securing plate comprises a fourth central opening; wherein the central shaft extends through the fourth central opening.

12. The pole assembly of claim 11, wherein the second outside securing plate is fixedly attached to the second yoke arm; wherein the second outside securing plate is rotatably attached to the central shaft.

13. The pole assembly of claim 12, wherein the second pivot arm comprises a fifth central opening; wherein central shaft extends through the fifth central opening.

14. The pole assembly of claim 13, wherein the second inside securing plate comprises a sixth central opening; wherein the central shaft extends through the sixth central opening; wherein the second inside securing plate is fixedly attached to the second pivot arm.

15. The pole assembly of claim 14, wherein the second pivot arm is fixedly attached to the second upper anchor mount; wherein the second upper anchor mount is attached to the first upper pole section.

16. The pole assembly of claim 15, wherein the second inside securing plate and the second pivot arm are rotatably attached to the central shaft.

17. The pole assembly of claim 16, wherein the first yoke arm comprises a first semi-circular cradle mount; wherein the second yoke arm comprises a second semi-circular cradle mount.

18. The pole assembly of claim 17, wherein the first and second lower anchor mounts are embedded within the second lower pole section.

19. The pole assembly of claim 18, wherein the first and second upper anchor mounts are embedded within the first upper pole section.

20. The pole assembly of claim 19, wherein the central shaft is comprised of at least a first shaft section and a second shaft section.

21. The pole assembly of claim 20, wherein the central hinge assembly comprises a central tube section; wherein the central tube section is hollow; wherein at least first portions of the first shaft section and the second shaft section are inserted within the central tube section; wherein the first shaft section and the second shaft section are detachably connected to the central tube section.

22. The pole assembly of claim 21, wherein the first shaft section is secured to the central tube section with a first securing pin; wherein the second shaft section is secured to the central tube section with a second securing pin.

23. The pole assembly of claim 22, wherein the central shaft comprises at least a first lifting ear and a second lifting ear.
